(19) United States
(12) Patent Application Publication
(10) Pub. No.: US 2005/0246317 A1
(43) Pub. Date: Nov. 3, 2005

(54) Matching engine

(75) Inventors: Michael Turner, York (GB); Paul Zanelli, Worcester (GB); Simon Moss, York (GB)

Correspondence Address: BEYER WEAVER & THOMAS LLP, P.O. BOX 70250, OAKLAND, CA, 94612-0250, US

(73) Assignee: Square Pi Limited

(21) Appl. No.: 11/053,183

(22) Filed: Feb. 7, 2005

Related U.S. Application Data
(63) Continuation of application No. 09/913,921, filed on Jan. 24, 2002, now abandoned.

(30) Foreign Application Priority Data
Feb. 19, 1999 (GB) 9903697.2

(51) Int. Cl. G06F 7/00

(52) U.S. Cl. 707/2

(57) ABSTRACT

A method of identifying the best matches or sets of matches between a query item and an item or items from a data set. The method includes the steps of: (i) providing a data representation for each item in the data set; (ii) providing a query representation of the query item; (iii) defining a transformation space; (iv) for each of a number of regions spanning the entire transformation space, determining an upper bound to the probability of a match between the query representation and a data representation under any transformation in the region; (v) determining a threshold probability; (vi) comparing the upper probability bound of each region with the threshold probability; and (vii) determining regions having an upper probability bound greater than the threshold probability, so as to identify solution regions.

This is a Continuation application of co-pending prior application Ser. No. 09/913,921 which is the U.S. National Phase of International Application No. PCT/GB00/00492 filed on Feb. 16, 2000 which designated the United States, the disclosure of which is incorporated herein by reference.

### BACKGROUND OF THE INVENTION

The present invention relates to a matching engine, and in particular to an engine for identifying the best matches or sets of matches between a query item and one or more items in a set of data.

Currently, there are a multitude of matching techniques. These current techniques may be split into two broad categories: gradient-based methods and exhaustive search. Examples of the former include gradient descent, simulated annealing, relaxation labelling, neural networks and genetic algorithms. All of these techniques take a few initial best guess match solutions and refine them in order to obtain better solutions.

The second category is exhaustive search techniques, in which a large number of match solutions are examined by coarsely sampling the solution space, and the best solution chosen. An example of an exhaustive search technique is the fast access method called geometric hashing.

There are problems associated with both of the above categories of techniques. They are slow and give poor performance on non-trivial matching problems. There are a number of reasons for this poor performance. Gradient-based methods depend critically on obtaining a good initial solution; i.e. initial-guess match or transformation. However, this is not always possible as obtaining a good match is the final aim of the technique. Exhaustive search methods are dependent on the resolution with which the solution space is searched. For matching, the space is exponential in the number of nodes, making it very unlikely that a good solution can be found in a practicable time.

### SUMMARY OF THE INVENTION

According to a first aspect of the invention there is provided a method of identifying the best matches, or best sets of matches, between a query item and one or more items from a data set, comprising the steps of providing a data representation of each item in the data set, providing a query representation of the query item, providing a parameterised transformation space, for each of a number of overlapping regions of the transformation space spanning the entire transformation space, determining an upper bound to the probability of a match between the query representation and the data representation under any transformation contained in the region, determining a threshold probability, comparing the upper probability bound of each region with the threshold probability and determining regions of the transformation space having an upper probability bound greater than the threshold probability, so as to identify solution regions.

The matching engine method of the invention provides a process which leads to the disovery of better solutions to matching problems; i.e. identifying objects with similar features. The method includes the steps sketching an upper boundary of all of the solution horizon, by obtaining an upper bound probability for large, overlapping regions of the space, thereby ensuring that the entire space is covered. Given this coarse sketch it is possible to eliminate highly implausible regions of the solution space and resketch the new upper boundary, by computing a threshold and eliminating regions of the space that fall below that threshold. The sketch and eliminate process can be repeated so as to naturally hone in on the diverse good solutions to the matching problem.

Once the probability of a match between the query item and the item from the data set has been determined by the identification of a solution region, the item from the data set can be identified as either being a plausible match or not based on a further criteria. The remaining items from the data set can then also be evaluated to identify either the best matching data item or the set of best matching data items from the entire data set.

Decisions about the solution horizon are no longer forced, but emerge naturally as processing proceeds. The invention provides a number of advantages compared to conventional approaches. The method delays and softens decision making, allowing many interpretations to be maintained early on in processing, and to be passed on for subsequent processing. Fewer cycles can be employed dramatically reducing processing resource requirements. The method can handle high dimensional, complex data without difficulty because as the number of dimensions increases it is a simple matter to correspondingly increase the size of the sketched regions. The method has a strong theoretical framework underpinned by probability theory.

Moreover, the method not only provides better performance within a module, it allows for step-change improvements within systems as a whole. Conventionally, system processing consists of passing best-guess solutions through a sequence of modules; i.e. the best guess output from one module forms an input to its neighbour. Since the best guess solution is often not the best actual solution, errors propagate and multiply, and cannot be subsequently rectified. According to the invention, not just the best guess, but all plausible solutions (i.e., those above a threshold) are passed between modules without compromising computational resources. It is only later on in processing when additional information has been brought to bear that solutions are excluded. The result is that good, diverse solutions naturally emerge from a system utilising the method.

The method can include the further steps of sub-dividing the solution regions into further regions which span the solution regions, determining a new upper bound, determining a new threshold probability and determining new solution regions. Repetition of the sketching and elimination process in the solution regions of the solution space containing plausible solutions enables all the plausible solutions in the transformation space to be more accurately identified.

The method can include the step of iterating the further method steps so as to identify the region of the transformation space containing the best match between the query and data set item. By repeated iteration the method can result in identifying a region containing the best solution or, depending on the termination criteria of the method a set of solution regions containing the best solutions can be identified.

The method can be applied to a single item in the data set or can be carried out for each of the individual items in the data set, or for a selected subset of items from the data set.

The method can terminate when all upper bounds of the solution regions exceed the threshold probabilities. The threshold can be heuristically increased to restart the determination process on the remaining solution regions or solution representations can be recorded and/or processed in a conventional way. The method can include the step of applying a gradient-based technique to determine a local maximum. This is acceptable as a final stage as the solution regions will only contain the plausible solutions.

The data representations can be topological representations of the data items and the query representation can be a topological representation of the query item. In using a spatial or topological representation of the data items and query item, the matching method is essentially one of pattern recognition.

The topological representation of the data items and query item can comprises a set of node measurement vectors, each node measurement vector being associated with a node of a topological arrangement of nodes defining the items. The data items to be searched and the query item to be matched with can have their properties defined by a set of topologically or spatially arranged nodes. A set of node measurement vectors for each item can then provide the representation of that item which is used in the matching method. The matching is then achieved essentially through pattern recognition. The method is a generally applicable to matching patterns which can be held in computer memory.

The upper bound can be determined using Bayesian probability theory.

According to a further aspect of the invention there is provided a matching engine for identifying matches between a query item and an item or items from a data set, the engine comprising electronic data processing apparatus including a memory storing a set of data representations of each item in the data set, an input for inputting a query representation of the query item and a processor which includes means for defining a parameterised transformation space, means for generating a number of overlapping regions of transformation space spanning the entire transformation space, means for determining for each region an upper bound to the probability of a match between the query representation and a data representation under any transformation in the region, means for determining a threshold probability, a comparison means which compares the upper probability bound for each region with the threshold probability, means to identify solution regions having an upper probability bound greater than the threshold probability, and means to store an identification derived from the solution region of the match between the query item and data set item in a memory.

According to a further aspect of the invention there is provided a computer program which when running on a computer carries out a method according to the first aspect of the invention. According to a yet further aspect of the invention there is provided a computer program which when loaded into a computer provides a matching engine according to the second aspect of the invention.

According to a further aspect of the invention there is provided computer program code for identifying an item or items from a data set, the code including instructions for carrying out the functions of providing a data representation of each item in the data set, providing a query representation of a query item, defining a parameterised transformation space, for each of a number of overlapping regions of the transformation space spanning the entire space, determining an upper bound to the probability of a match between the query representation and a data representation under any transformation in the region, determining a threshold probability, comparing the upper probability bound of each region with the threshold probability so as to identify solution regions which do contain solutions which match the database item to the query item.

According to a further aspect of the invention there is provided a computer readable medium storing computer program code according to the above aspect of the invention. The medium can be a permanent, semi-permanent, or temporary storage or memory device, or can be an electrical signal transmitted by wireline or wirelessly.

### BRIEF DESCRIPTION OF THE DRAWINGS

An embodiment of the invention will now be described in detail, by way of example only, and with reference to the accompanying drawings, in which:

FIGS. 1a,b,c & d shows a series of solution space diagrams illustrating steps of the method according to the invention; and

FIG. 2 shows a flow chart schematically illustrating a software aspect of the invention.

### DETAILED DESCRIPTION OF THE EMBODIMENTS

As an example, the problem of automatically matching molecules in order to maximise some similarity criterion will be discussed. This is an important problem in the drug development process. Chemists will have a ‘query molecule’ of known behaviour and wish to use it to search a database for similar molecules. This can be viewed as an optimisation problem i.e., finding the best alignments (matches, transformations) between a query item and a database of items (molecules) from a large number of possible molecules and their alignments. The query item molecule and database molecule items can be represented as patterns by placing nodes at regular intervals on their surface, and a measurement vector (containing characteristic properties of the molecule, e.g. spatial and eletrostatic information) can be associated with each node. Thus, a pattern matching problem results.

In this context the term node is considered to mean . . . and includes . . . Further, the term measuerement vector is considered to mean . . . and inlcudes . . .

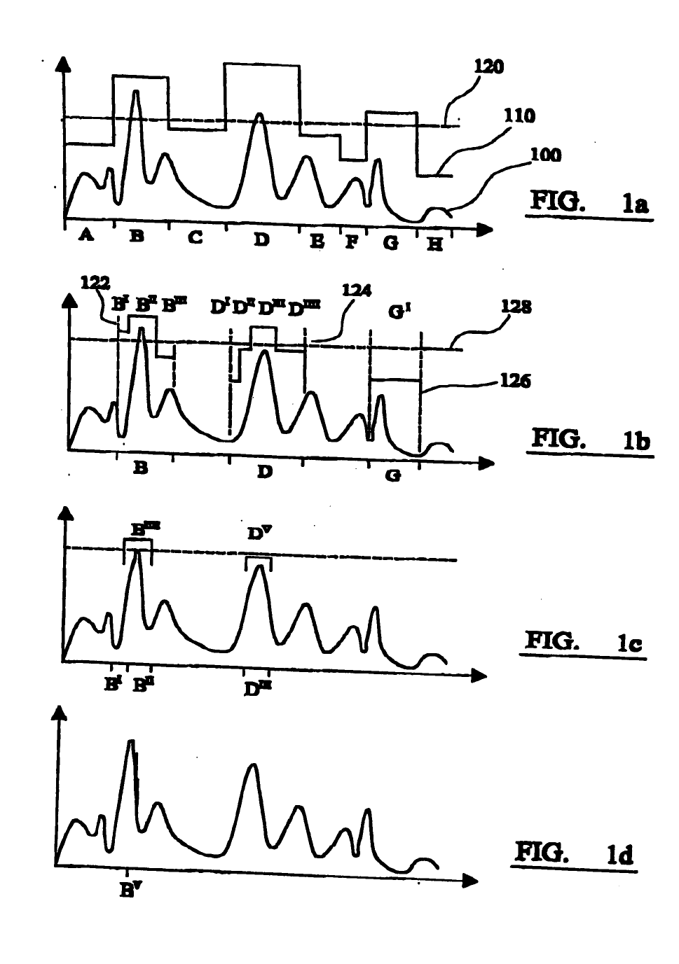

FIG. 1 shows a series of sketches of a solution surface for this problem. The x-axis represents the possible alignments of the query molecule with a molecule in the database and the y-axis represents the similarity or goodness fit for all the different alignments. Each point on the curve represents the goodness of fit of the query molecule to the database molecule under a possible transformations (i.e. the curve may be thought to sketch out the similarity between the properties of the moleule as one is rotated or translated relative to the other). The peaks and troughs represent good and bad fits respectively between two molecular structures, and the aim is to find the highest peaks.

As discussed previously, conventional techniques for optimisation can be grouped into two general categories—exhaustive search and gradient-based methods. Exhaustive search techniques, for example geometric hashing and gnomonic projection, try to identify peaks by jumping incrementally on the solution surface. The number of good solutions that can be identified relates directly to the step resolution. While it is theoretically possible to find all the good solutions by letting the step increment tend to zero, in practice this results in a corresponding exponential increase in processing resource requirement (typically processor speed and memory requirements). There is an unfavourable trade off between speed to a solution and quality of the result.

Conventionally, gradient based method have been the only alternative to exhaustive search techniques. They include gradient descent, simulated annealing, neural networks, the Expectation Maximisation (EM) algorithm and Genetic Algorithms (GAs), as examples. At each incremental step a routine is activated which ascends up to a local peak and identifies its location. Having found one peak it may jump through another increment and the process is repeated. However, like the exhaustive search technique it is limited in that the quality of solution is balanced against speed of processing. In particular, the quality of the solutions found depends upon where on the solution horizon the ascent is started. A good solution can only be found if a reasonable solution is known beforehand, which is not the case in general. Processing usually begins at some random position leading to a poor solution on termination.

Since all drug development technology is based on exhaustive search or gradient-based methods, the discovery process is time-consuming and expensive since poor performance means that many cycles are necessary between experiments and computational analysis to hone in on a suitably active compound.

The present invention delivers a step-change in technology to speed up the drug development process. In particular, it provides an engine for searching and comparing molecules held in large 3D chemical databases. In practice, the engine has been found to carry out an analysis over 1,500 times faster than conventional commercially available packages operating on the same hardware. This allows large databases to be searched in seconds rather than days, and opens the way to truly interactive computational drug design on the desktop.

Moreover, the invention gives better quality analyses, in that it identifies a better set of molecules to test experimentally. This in turn reduces the number of cycles that are needed in the development process, leading to faster and more cost-effective drug development.

The invention provides a new method of matching which is fast and gives good performance. The approach is based on a new approach to pattern recognition based upon four key factors. The matching problem is formulated as one of finding the best set of transformations between the nodes in two patterns. Calculations used in the method are underpinned by Bayesian probability theory. The method is holistic in that it requires that all possible solutions must be examined. The data processing is resource-driven such that the calculations that can be performed are constrained by the memory available and the speed of operations required, as defined by the operator.

The latter two considerations could lead to the conundrum of how to look at an exponential number of solutions quickly and efficiently. This is overcome by collecting solutions together into a small number of (typically overlapping) subsets or regions of the total set of possible solutions, and assessing each region or subset in turn. There are a number of estimates that may be made on a region, and an effective strategy that is consistent with the processing resource constraint allows a trade-off between speed and accuracy by obtaining upper and lower bound scores (probabilities) for any solution contained with a region or subset.

Given these conditions, the optimal strategy to take is to eliminate regions if their upper bound falls below the highest lower bound. This guarantees that the optimal solution will be retained. By repeating this operation it is possible to hone in on interesting regions of the solution space by excluding sub-optimal solutions. The remaining solutions may be re-examined in increasing detail as processing proceeds and as the processing constraint condition allows. The process terminates when all upper bounds exceed the lower bound threshold. At this point the lower bound may be heuristically increased to re-start the elimination process, or alternatively the remaining transformations may be recorded and processed in some conventional way. Typically a gradient-based approach can be employed since the regions that remain will contain the peaks of interest. Once the match between the query molecule and that molecule has been assessed other molecules in the database can also be processed to assess their goodness of match.

With reference to FIGS. 1a to d, a brief schematic illustration of the general features of the method will be given before giving a more detailed description of the method. In FIG. 1a , the y axis represents the goodness of fit or the probability of a match. The x-axis represents the set of all allowed transformations (e.g. rotations, transformations) between molecules. The query molecule for which a match is to be identified is represented as a query representation. The molecule from the database or data set with which the query molecule is being compared is represented as a data representation. The curve 100 is an indication of the closeness of the match between the representation of the query molecule with the representation of the database molecule under different transformations. The problem is to identify the peaks in the curve representing plausible solutions without omitting any plausible solutions in a practicable manner.

Firstly, the set of transformations is divided into a number of regions A to H which span the entire transformation space. For each of those regions an upper bound to the probability of the match between the data representation and the query representation under any transformation in the regions is calculated using Bayesian probability theory. The results of such a calculation are shown as line 110. A threshold probability is then calculated as shown by dashed line 120. Those regions having their upper probability bound 110 falling below the threshold 120, in this case subsets A, C, E, F and H are then removed as there are clearly better matches available within solution subsets B, D and G.

As illustrated in FIG. 1b transformation regions B, D and G are then subdivided into a number of further regions: B′,B″ and B′″,D′, D″, D′″ and D″″ and G′. A new upper bound on the probability of matching with the query representation is determined for each of the regions as illustrated by lines 122, 124 and 126. A new threshold probability is calculated, as illustrated by line 128. Again, those regions falling below the threshold value are removed from the solution space such that only solution regions B′, B″ and D′″ remain for further processing. At this stage the process could be terminated and the solutions containing identified matches given by the molecule and its transformations falling within solution regions B′, B″ and D′″ could be saved, resulting in a set of regions containing the best fit solutions. The molecule can then be identified as one providing an acceptable match dependent on some further matching criteria.

Alternatively, a further iteration of the process could be carried out as illustrated in FIG. 1c. Further upper probability bounds 130 and 132 for subsets B″″ and D^{v} are calculated and compared with a newly derived probability threshold to identify solution region B″″. In a final step a gradient method is utilised to find the local maximum solution representation B^{v} which has a corresponding transformation identified as giving the best match to the query molecule. The match with the remaining molecules in the database can then be assessed individually.

Turning now to the use of a spatial arrangement of nodes to represent the characteristic features of the molecules which provide the pattern to be matched by the method. Consider a pattern labelled by a set of N nodes. The nodes have an associated set of measurement vectors, x={x₁, □ . . . , x_{N}}.

In order to match the pattern against a second, consider the global set of transformations which map the nodes in the first pattern onto the second and is denoted by w={w₁, . . . , w_{N}}. From the first condition discussed above, the aim is to find the best global solution, i.e., the best set of transformations from the nodes in this pattern to a second pattern, where, from the second and third conditions an holistic, probability theory approach, is used which requires:
w=arg max_{?eW}P(W=?|x) (1)
where W is the space of possible solutions for w. In other words, all of the solution space is considered, making no a priori assumptions about where or how often to search.

Note there is no aim to locate the best solution directly, i.e., by actively searching for or refining solutions within W, this being the approach of existing gradient-based or exhaustive search techniques. Rather, the method achieves the same aim indirectly, by eliminating bad solutions from W. In doing so all of the solution space is implicitly examined, as required by the third condition. This is achieved as follows.

Solutions are collected together since examining each individual solution in isolation would be computationally intractable in general. This is done by considering all solutions that contain the individual transformation wᵢ=a, say, i.e., all solutions where the transformation for node i is fixed to be wᵢ=a (or, more precisely, in some small vicinity thereof), but the transformations of all other nodes may vary. The lowest upper bound for any one of these solutions (i.e., a region of the solution space) is such that:
U(wᵢ=a)=max_{w′eW′}P(wᵢ=a,w′|x) (2)
where w′ denotes the transformations on all nodes excluding that under consideration, and W′ is the space of all possible transformations for this set.

Any region whose upper bound probability is below some known lower bound value, L, say, of interest cannot contain the optimum solution. Therefore, it is possible to eliminate these regions from consideration. Therefore the rule at some iteration time n is:
eliminate the region containing the transformation wᵢ=a if
   U⁽ⁿ⁾(wᵢ=a)<L⁽ⁿ⁾ (3)
   This is the key to the method: an upper bound on the probability of region of the solution space can be computed. (At the onset the whole of the solution space can be covered, generating an upper bound sketch as in FIG. 1a). Each region or subset can then be compared against a lower bound threshold. If the upper bound falls below the threshold the region can be eliminated since it cannot contain a good solution.

The computation of the upper bound has not yet been defined, and in general may be computationally expensive. In order to provide a computational practicable method, a solution is to identify quantities of the form G⁽ⁿ⁾ (wᵢ=a) such that G⁽ⁿ⁾ (wᵢ=a)>=U⁽ⁿ⁾ (wᵢ=a) which can be computed in a given time. In other words, rather than compute the lowest upper bound, U, some upper bound, G, is computed. Thus, computational resources drive processing and provides a computationally tractable method which can be used to provide real time results. The method can provide an optimal use of allowed computational resources when G is as close to U as possible. The elimination rule then becomes:
eliminate the region containing the transformation wᵢ=a if
   G⁽ⁿ⁾(wᵢ=a)<L⁽ⁿ⁾ (4)
   G⁽ⁿ⁾ is evaluated by combining Bayesian probability theory with rules of inequality. Its form may change over the iterative cycles in order to accommodate the computational resource requirement. For example, at the onset of processing G⁽ⁿ⁾ may be coarsely and quickly evaluated, providing a coarse upper bound sketch (FIG. 1a) but provided it obeys G⁽ⁿ⁾>=U⁽ⁿ⁾ then only bad solutions will be eliminated.

This frees up resources so that the surviving solution space or solution subsets can be examined in more detail if required. It also allows for lower upper bounds to be computed at the next iteration since there is less interference in the system since the elimination of one region affects the bound computed for overlapping regions at the next time step.

Towards the end of processing when only a few solutions remain, a more sophisticated and computationally intensive means of computing G⁽ⁿ⁾ may be employed, such that G⁽ⁿ⁾ approximates L⁽ⁿ⁾ provided the fourth condition is not violated.

Processing will continue until no solutions fall below the threshold.

At any time processing may be re-started by heuristically increasing the threshold, or alternatively, the remaining transformations may be recorded and processed in some manner.

In essence G is computed to sketch the solution surface, which is compared against the threshold L to eliminate uninteresting regions of the space. No other method is known of which uses such an holistic sketch and elimination process.

The example the method so far discussed is retrieval of bio-active compounds from chemical databases by using one or more query or lead compounds a cue. The starting point is to represent query and database compounds as patterns, each identified by a set of spatially or topologically arranged nodes, each node having an associated measurement vector.

Initially U(wᵢ=a) is defined and then an inequality is introduced to generate G(wᵢ=a).

The upper bound probability in equation (2) can be developed. By applying Bayes' rule equation (2) becomes
U(wᵢ=a)=max_{w′ew′}p(x|wᵢ=a,w′)P(wᵢ=a,w′)/p(x) (5)

Making the non-restrictive assumption that the measurement vectors x={x₁, □ . . . , x_{N}} are independent when conditioned on the transformations w={w_{1,} . . . , W_{N}} then this becomes
U(wᵢ=a)=p(xᵢ|wᵢ=a)P(wᵢ=a)max_{w′eW′}P_{j!=i}p(xⱼ|wⱼ)P(w′|wᵢ=a,)/p(x (6)

An inequality is introduced to reduce computational complexity. An option is
max_{aeA,beB}P(a,b)<=max_{aeA}P(a)max_{beB}P(b) (7)
which gives
U(wᵢ=a)<=p(xᵢ|wᵢ=a)P(wᵢ=a) p_{j!=i}max_{βeWj}p(xⱼ|wⱼ=β)P(wⱼ=β|wᵢ=a)/p(x)=G⁽ⁿ⁾(wᵢ=a) (8)

Where Wⱼ is the set of possible transformations for node j, and which reduces the complexity of the upper bound calculation from exponential to O(N²). Alternative inequalities could be applied here leading to increases or decreases in complexity, as required.

Equivalent to equation (4) is:
eliminate the transformation wᵢ=a from the list W⁽ⁿ⁺¹⁾ᵢ if
   G⁽ⁿ⁾(wᵢ=a)<L⁽ⁿ⁾ (9)

Where G⁽ⁿ⁾ (wᵢ=a) is given in equation (8).

Taking logarithms, the elimination rule then becomes:
eliminate the transformation wᵢ=a from the list W⁽ⁿ⁺¹⁾ᵢ if
   S⁽ⁿ⁾(wᵢ=a)<log L⁽ⁿ⁾ (10)
   where S⁽ⁿ⁾ (wᵢ=a) is given by:
   S⁽ⁿ⁾(wᵢ=a)=log(p(xᵢ|wᵢ=a)P(wᵢ=a))+S_{j!=i}max_{βeWj}⁽ⁿ⁾ log p(xⱼ|wⱼ=β)P(wⱼ=β|wᵢ=a) −c (11)
   Where c=log p(x) is a constant and the algorithm can be applied to all candidate transformations at all nodes, synchronously or asynchronously

Application of the method requires models for the distributions and priors in equation (11). For the application of molecule matching one alternative is rectilinear distributions with zero height away from their centre. In this case the support for an individual transformation is:
S⁽ⁿ⁾(wᵢ=a)=k S_{j!=i}max_{βeWj}⁽ⁿ⁾h(wᵢ=a, wⱼ=β) (12)
for n>0, where k is a constant and where all solutions not compatible with the data have been eliminated at the onset. Here h(wᵢ=a, wⱼ=β) is a binary compatibility measure, simply stating if the transformation a on node i is compatible with the solution β on node j at time n. Thus S⁽ⁿ⁾ (wᵢ=a) essentially counts the number of nodes that may be consistent with the transformation under consideration at node i.

The procedure can combine the algorithm in (12) with geometric hashing. It involves a storage stage in which database compounds are encoded in a hash table, and a recall stage in which a query compound is used to access the table, and regions are examined. Finally, a clustering or searching stage may be added to closely analyse remaining regions.

When the method is embodied as a computer program the following functions are supported.

The following steps are taken in storage for each database compound:
generate the database compound nodes, and their measurement vectors to include node position and normal;
generate a frame for each point using the centroid-position-normal triplet;
align this frame to the world frame and store the compound in a hash table as compound-node-transformation triplets;

The following steps are taken in recall:
generate the query compound to define the object nodes, their positions and normals;
generate a frame for each node using the centroid-position-normal triplet;
align this frame to the world frame and access the hash table, assigning accessed transformations to each node;
convert the transformation matrices to rotation parameters and store in a hash table;
use the sketch and eliminate procedure in equations (12) and (10) to eliminate implausible rotation solutions;
cluster the remaining solutions and obtain a similarity index score for each by overlaying compounds

Modifications to the description above for different applications occur at the level of modelling. This may either be alterations to the form of the distributions assumed or to the measurement features employed. For example, in the molecule matching rectilinear distributions have been used but in this and other applications Gaussian distributions may be appropriate and, for example, curvature information may be employed.

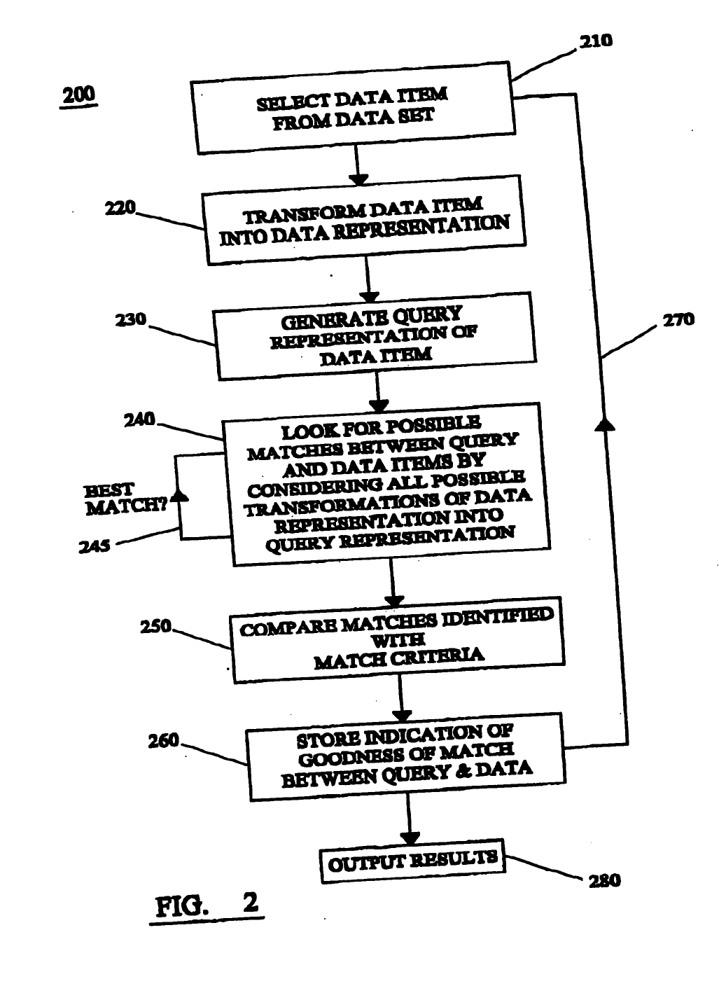

With reference to FIG. 2 there is shown a schematic flow diagram 200 of a software implementation of an aspect of the invention. Initially a data molecule is selected from the database at step 210. The data molecule is then transformed into a data representation of that molecule 220 in the form of a set of node measurement vectors as described above. A representation of the query molecule is then generated 230 again as a set of node measurement vectors. This step need not be repeated in subsequent runs, and once generated the query representation may be stored for further use as required.

The match between the query and data representations is then determined 240 by looking at the possible transformations between the query and data representations so as to identify possible solution regions in the transformation space. This step may be iterated 245 so as to determine only the best match or alternatively to determine a set of best matches, as described above.

A match criteria can then be applied 250 to the best or set of best matches so as to determine whether the query and data item match sufficiently well. If the query and data item match sufficiently well then an indication of the data item and its goodness of match is stored 260 for future reference or processing. The remaining items in the data base can then be compared with the query item 270 until all or a selected amount of the database has been searched. The results, which identify database compounds which sufficiently match the query compound, can then be output 280. The results of all the attempted matches can be stored and arranged in order of goodness of match to identify a hierarchy of likely compounds.

Under different models and using different measurements there are a wide number of application areas for the matching engine of the invention. Each has at its core the problem of matching complex patterns. The matching engine can be used to identify features (items) in visual data sets, e.g. in medical image analysis, visual inspection and control, 3D reconstruction from video or film and 3D object monitoring in video or film. In visual data applications, the full data set of visual signals can be searched so as to identify features in the video signals by matching the pattern of the feature being searched for with the patterns present in the video signals. As the method is holistic and covers the entire data set, there is no loss of definition in the video signals.

For instance the matching engine could be used to identify a particular article, e.g. a mug, in a stream of video signals. In this case, the mug would be the query item for which a topological query representation would be generated. The data item would then be a video frame still. The location of the mug in the video still picture could then be identified by the matching engine by searching through the video still data item by considering all possible transformations of the mug representation and then identifying the mug in the video still. In this case the sequence of video still images would be the database items which could be searched in turn by the engine to identify the location of the mug in the video images. The application of the matching engine to identify patterns in medical images (both video and ultrasound) so as to locate body or tissue features will also be appreciated from this example.

The matching engine can also find applications in the fields of DNA and protein sequence matching as will be appreciated. The matching engine can also be applied to the field of predicting financial events, by matching patterns in current and old financial data sets and correlating those matches with past financial events, e.g. predicting the movement of stocks, bond prices and other financial instruments.

It will be appreciated that the method is particularly suited to implementation as a computer program, and that suitably programmed electronic data processing apparatus will provide a search engine capable of carrying out the pattern matching method as described. The detailed requirements of a computer program embodying the method described herein are considered to be within the abilities of a man of ordinary skill in the art of computer programming and so have not been described in any detail.

1. A method of identifying the best matches or sets of matches between a query item and an item or items from a data set, the method comprising the steps of:
(i) providing a data representation for each item in the data set;
(ii) providing a query representation of the query item;
(iii) defining a transformation space;
(iv) for each of a number of regions spanning the entire transformation space, determining an upper bound to the probability of a global match between the query representation and a data representation under any global transformation in the region;
(v) automatically determining a global threshold probability based on the upper bound determined in (iv);
(vi) comparing the upper probability bound of each region with the global threshold probability;
(vii) determining regions having an upper probability bound greater than the global threshold probability, so as to identify solution regions;
(viii) sub-dividing the solution regions into further regions which span the solution regions;
(ix) determining a new upper bound to the probability of a global match between the query representation and a data representation under any global transformation in the further regions;
(x) determining a new global threshold probability based on the new upper bound; and
(xi) determining new solution regions.

2. A method as claimed in claim 1, including the step of iterating steps (viii) to (xi) so as to identify the solution region containing the best matching solution or to identify a set of solution regions containing a set of best matching solutions.

3. A method as claimed in claim 1, in which the data representations are topological representations of the data items and the query representation is a topological representation of the query item.

4. A method as claimed in claim 3, in which the topological representation of the data items and query item comprises a set of node measurement vectors, each node measurement vector being associated with a node of a topological arrangement of nodes defining the items.

5. A method as claimed in claim 1, in which the upper bound is determined using Bayesian probability theory.

6. A matching engine for identifying an item or items from a data set, the engine comprising electronic data processing apparatus including:
a memory storing a data representation for each item in the data set;
an input for inputting a query representation of the query item; and
a processor configured to
define a transformation space,
generate a number of regions of the transformation space spanning the entire transformation space,
determine for each region an upper bound to the probability of a global match between the query representation and a data representation under any global transformation in the region,
determine a global threshold probability based on the upper bound,
compare the upper probability bound for each region with the global threshold probability,
identify solution regions having an upper probability bound greater than the global threshold probability,
sub-divide the solution regions into further regions which span the solution regions,
determine a new upper bound to the probability of a global match between the query representation and a data representation under any global transformation in the further regions,
determine a new global threshold probability based on the new upper bound;
determine new solution regions; and
store an identification of a match between the query item and the item of the data set in a memory.

7. A computer program which when running on a computer carries out a method as claimed in claim 1.

8. A computer readable medium bearing computer program code providing instructions causing a computer to carry out the data processing operations of:
(i) provide a data representation for each item in the data set;
(ii) provide a query representation of the query item;
(iii) define a transformation space;
(iv) for each of a number of regions spanning the entire transformation space, determine an upper bound to the probability of a global match between the query representation and a data representation under any global transformation in the region;
(v) automatically determine a global threshold probability based on the upper bound determined in (iv);
(vi) compare the upper probability bound of each region with the global threshold probability;
(vii) determine regions having an upper probability bound greater than the global threshold probability, so as to identify solution regions;
(viii) sub-divide the solution regions into further regions which span the solution regions;
(ix) determine a new upper bound to the probability of a global match between the query representation and a data representation under any global transformation in the further regions;
(x) determine a new global threshold probability based on the new upper bound; and
(xi) determine new solution regions.
